(19) United States
(12) Patent Application Publication
(10) Pub. No.: US 2026/0156001 A1
(43) Pub. Date: Jun. 4, 2026

(54) QUANTUM-RESISTANT PUBLIC KEY CERTIFICATION SYSTEM AND METHOD OF CERTIFICATION CONSIDERING THE USAGE ENVIRONMENT

(71) Applicant: INSTITUTE FOR BASIC SCIENCE, Daejeon (KR)

(72) Inventor: Kyungah SHIM, Daejeon (KR)

(73) Assignee: INSTITUTE FOR BASIC SCIENCE, Daejeon (KR)

(21) Appl. No.: 18/948,111

(22) Filed: Nov. 14, 2024

(30) Foreign Application Priority Data
Oct. 21, 2024 (KR) 10-2024-0143621

(51) Int. Cl. H04L 9/32

(52) U.S. Cl. CPC H04L 9/3268

(57) ABSTRACT

Disclosed is a method of operating a certification server of a public key certificate

system. The method includes receiving a request for issuance of a public key certificate from a terminal, determining a terminal encryption scheme and a certification encryption scheme that are suitable for a public key certificate system, the terminal encryption scheme and the certification encryption scheme being encryption schemes allowed in the public key certificate system, generating a public key of the terminal according to the terminal encryption scheme, generating a public key certificate for verifying the validity of the public key of the terminal according to the certification encryption scheme, and transmitting the public key certificate to the terminal.

### TECHNICAL FIELD

Embodiments according to the concept of the present disclosure relate to a quantum-resistant public key certificate system and method of certification, and more specifically, to a quantum-resistant public key certificate system and method of certification considering a usage environment.

### BACKGROUND ART

Most modern encryption systems use a public key encryption system. For example, the public key encryption system can be used in any environment, such as an electronic signature system, a certification system, and a key distribution system. In the public key encryption system, a public key is paired with a private key. A key owner retains his or her private key so that only he or she can know the private key and distributes or transmits the public key so that anyone can use the public key.

Meanwhile, in the public key encryption system, the fact that his or her public key can be published to anyone also means that anyone can claim that the public key is his or hers. That is, since there is no guarantee as to who the legitimate owner of the disclosed public key is, a certification device therefor is needed.

A public key certificate is used as a means of certificating the legitimate owner of the public key. The public key certificate includes the corresponding public key and identification information about an owner of the corresponding public key and is signed by a trusted third party (e.g., a certification agency (CA)). Therefore, information about the owner included in the public key certificate can be certified as being information about the legitimate owner of the public key.

Meanwhile, the security of conventional public key encryption algorithms is threatened due to the development of quantum computers. In particular, classical public key encryption algorithms such as a Rivest-Shamir-Adleman (RSA) algorithm can be broken within a polynomial time according to Shor's algorithm, which can be implemented on quantum computers.

As an alternative, a post-quantum encryption algorithm is proposed, but since conventional authentication systems adopt one algorithm, the selection of an appropriate algorithm among algorithms is required.

### SUMMARY OF INVENTION

### Technical Problem

The present disclosure is directed to providing a quantum-resistant public key certificate system and a method of certification considering a usage environment.

### Solution to Problem

A method of operating a certification server of a public key certificate system according to embodiments of the present disclosure includes receiving a request for issuance of a public key certificate from a terminal, determining a terminal encryption scheme and a certification encryption scheme among encryption schemes allowed in the public key certificate system, generating a public key of the terminal according to the terminal encryption scheme, generating a public key certificate for verifying the validity of the public key of the terminal according to the certification encryption scheme, and transmitting the public key certificate to the terminal.

A certificating method of a public key certificate system including a first terminal and a certification server according to embodiments of the present disclosure includes receiving, by the certification server, a request for issuance of a public key certificate from the first terminal, determining, by the certification system or the first terminal, a terminal encryption scheme and a certification encryption scheme among encryption schemes allowed in the public key certificate system, generating, by the certification server, a public key of the first terminal according to the terminal encryption scheme, generating, by the certification server, a public key certificate for verifying the validity of the public key of the first terminal according to the certification encryption scheme, and transmitting, by the certification server, the public key certificate to the first terminal.

### Advantageous Effects of Invention

According to the embodiments of the present disclosure, in the certification system including the terminal and the certification server, the encryption scheme suitable for each subject can be selected in consideration of the usage environment of the certification system, thereby increasing the overall efficiency of the certification system. In particular, compared to the certification system using the same encryption scheme, an efficient certification system can be constructed in consideration of various factors such as a ciphertext generation speed, a verification speed, a certificate size, and a public key length.

### BRIEF DESCRIPTION OF DRAWINGS

Detailed description of each drawing is provided for better understanding for the accompanying drawings cited in the detailed specification of the present disclosure.

FIG. 1 shows a certification system according to embodiments of the present disclosure.

FIG. 2 shows a device according to the embodiments of the present disclosure.

FIG. 3 is a view for describing operations of a user terminal and a certification server according to the embodiments of the present disclosure.

FIG. 4 is a view showing the performance of encryption schemes according to the embodiments of the present disclosure.

FIG. 5 is a view for describing encryption scheme selection considering a usage environment according to the embodiments of the present disclosure.

FIG. 6 is a view for describing the encryption scheme selection considering the usage environment according to the embodiments of the present disclosure.

### DESCRIPTION OF EMBODIMENTS

FIG. 1 shows a certification system according to embodiments of the present disclosure. Referring to FIG. 1, a certification system 10 may provide a service for issuing, managing, and verifying a certificate for a public key, that is, a public key certificate, used in a public key encryption system.

According to embodiments, the public key certificate provided from the certification system 10 may be used to verify the validity of a public key in any encryption system using a public key method. For example, the public key certificate may be used to verify the validity of a public key used in an encryption system for an electronic signature, a key encapsulation mechanism, key distribution, key agreement, aggregate signature, homomorphic encryption, functional encryption, and functional signature.

In the case of the public key encryption system, there is a case in which one side performs encryption or decryption using a public key of the other side, and in this case, whether the other side is the true owner of the public key may be an issue. To solve this, the public key certificate is used.

For example, in the case of an electronic signature system, a sender (or a sending device) generates an electronic signature for a message using his or her own private key, and a receiver (or a receiving device) verifies the electronic signature using the sender's public key. In this case, the validation of the public key is required.

Likewise, in the case of a key encapsulation mechanism (KEM), a sender (or a sending device) encrypts a symmetric key (or a key seed for generating the symmetric key) using a receiver's (or receiving device's) public key and transmits the encrypted symmetric key, and the receiver decrypts the encrypted symmetric key using his or her private key. In this case, the validation of the receiver's public key is required before the sender encrypts the symmetric key using the receiver's public key.

To this end, a public key certificate may include a corresponding public key and identification information about the owner of the corresponding public key. Additionally, the public key certificate may further include an electronic signature based on a private key of a trust period (e.g., a certification server 120) for the public key and the identification information.

The certification system 10 includes a first terminal 110 and the certification server 120. According to embodiments, the certification system 10 may further include a second terminal 130.

The electronic devices 110, 120, and 130 are electronic devices including a calculation processing device and a communication circuit, such as a server computer, a mobile terminal, or a computer, but are not limited thereto. For example, the devices 110, 120, and 130 may store a program that performs an encryption operation and perform the encryption operation by loading the program. According to embodiments, the devices 110, 120, and 130 may store an encryption program for performing an encryption operation according to a predetermined encryption scheme.

That is, it can be understood that operations of the devices 110, 120, and 130 described in the present specification are performed under the control of the encryption program installed in each of the devices 110, 120, and 130. That is, the operations of the devices 110, 120, and 130 may correspond to the operation of the encryption program installed in each of the devices.

Meanwhile, the encryption scheme described in the present specification may be based on a specific mathematical problem. For example, the encryption scheme may be a quantum-resistant encryption scheme that is considered as being secured from attacks using quantum computers.

Here, the fact that the encryption algorithm is secured from attacks using quantum computers means that there is no quantum computer-based algorithm (i.e., a quantum algorithm) that decrypts the corresponding encryption algorithm within an efficient time. The opposite is also the case. The efficient time may be a time that is a polynomial time or less, but is not limited thereto.

For example, the quantum-resistant encryption scheme may be based on secure mathematical problems against quantum computing attacks, such as a lattice problem, a code problem, a multiplicative variable quadratic problem, an isogeny problem, and a hash function problem, but the embodiments of the present disclosure are not limited thereto.

The lattice problem is a problem related to finding the shortest vector on a predetermined lattice. For example, the lattice-based problem may include a learning with errors (LWE) problem and a short integer solution (SIS) problem on the lattice.

The code problem is a problem related to decoding general linear codes. For example, the code problem includes a syndrome decoding problem. For example, the encryption scheme based on a sign problem includes McEliece, Modern McEliece, Niederreiter, MCPC-McEliece, Wild McEliece, McBits, and the like, but is not limited thereto.

The multiplicative variable quadratic problem is a problem related to finding solutions to systems of multivariate quadratic defined on a finite field or a Galois field.

The isogeny problem is a problem related to finding isogeny between two elliptic curves.

The hash function problem is a problem related to a hash function that is a one-way function and includes, for example, a problem of finding a collision or second preimage of the hash function.

The first terminal 110 is a terminal of the owner (or subject) of the public key and may receive a public key certificate for his or her public key through the certification server 120. The public key certificate of the first terminal 110 may be distributed directly by the first terminal 110 or distributed by being stored in a separate storage.

According to embodiments, in the case of the electronic signature system, the first terminal 110 is a signature device for generating an electronic signature and may generate an electronic signature for a message using his or her public key and corresponding private key. The first terminal 110 may transmit the generated electronic signature and the public key certificate to the second terminal 130.

According to embodiments, in the case of the KEM method, the first terminal 110 may transmit his or her public key certificate to the second terminal 130 and receive a symmetric key (or key information for generating the symmetric key) encrypted with his or her public key from the second terminal 130. Thereafter, the first terminal 110 may decrypt the symmetric key encrypted with the public key using his or her private key.

The certification server 120 may generate and manage a certificate, i.e., a public key certificate, to ensure the validity of the public key used in the certification system 10.

According to embodiments, the certification server 120 may generate a public key certificate including the public key of the first terminal 110 and identification information about the owner of the corresponding public key. Additionally, the public key certificate may further include an electronic signature based on a private key of the certification server 120 for the public key and the identification information. In this case, the public key certificate generated by the certification server 120 may be transmitted to the first terminal 110.

The second terminal 130 is a device for receiving or using the public key of the first terminal 110 and may receive the public key and/or public key certificate of the first terminal 110 and verify the validity of the public key of the first terminal 110. In this case, the second terminal 130 may verify the public key certificate using the public key of the certification server 120.

According to embodiments, in the case of the electronic signature system, the second terminal 130 is a verification device for verifying an electronic signature and may verify the validity of the public key through the public key certificate of the first terminal 110 and verify the electronic signature of the first terminal 110 using the public key of the first terminal 110.

According to embodiments, in the case of the KEM method, the second terminal 130 is a key transmission device for transmitting a symmetric key and may verify the validity of the public key through the public key certificate of the first terminal 110, encrypt the symmetric key (or key information for generating the symmetric key) using the public key of the first terminal 110, and transmit the encrypted symmetric key to the first terminal 110.

Meanwhile, according to embodiments, the second terminal 130 and the certification server 120 may be the same device. For example, the certification server 120 may issue the public key certificate for the first terminal 110 and then receive the public key certificate from the first terminal 110 to verify the public key certificate. That is, the second certification server 120 may also verify the public key certificate it has issued. This case is a case in which a certification agency and a verification agency are the same.

In the certification system 10 according to the embodiments of the present disclosure, a hierarchy may be formed between the first terminal 110 and the certification server 120. Specifically, the certification server 120 may verify the validity of the public key of the first terminal 110. For example, the certification server 120 may generate and manage the public key certificate for the public key of the owner of the first terminal 110.

In the present specification, an upper-level subject may issue a public key certificate to prove the validity of a public key of a lower-level subject. That is, a subject receiving validity certification is the lower-level subject, and a subject providing validity certification is the upper-level subject. For example, in the case of FIG. 1, the first terminal may be the lower-level subject, and the certification server may be the upper-level subject. In addition, although not shown in FIG. 1, a root certification server may be present as an upper-level subject of the certification server. In this case, the root certification server may be the upper-level subject, and the certification server may be the lower-level subject.

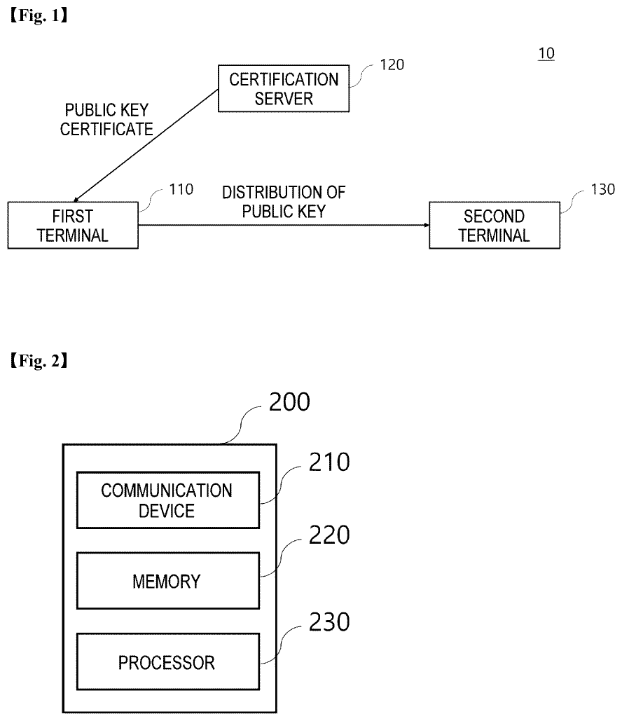

FIG. 2 shows a device according to the embodiments of the present disclosure. Referring to FIG. 2, an electronic device 200 may be the devices 110, 120, and 130 of FIG. 1.

The electronic device 200 may include a communication circuit 210, a memory 220, and a processor 230.

The communication circuit 210 may exchange data with an external device. According to embodiments, the communication circuit 210 may exchange data according to a wired communication protocol or a wireless communication protocol. For example, the communication circuit 210 may exchange information required to perform an encryption operation, an electronic signature operation, a key distribution operation, and the like that are performed by the electronic device 200. In addition, the communication circuit 210 may exchange data with an external server.

The memory 220 may store data required for the operation of the device 200. According to embodiments, the memory 220 may store a program including commands to perform the encryption operation, the electronic signature operation, and the key distribution operation. The device 200 may perform the encryption operation, the electronic signature operation, and the key distribution operation by executing the program stored in the memory 220. For example, the memory 220 may store commands (i.e., algorithms) to perform electronic signature schemes used in the encryption operation.

The memory 220 may be a volatile memory or a non-volatile memory.

The processor 230 may control the overall operation of the device 200. According to embodiments, the processor 230 may have a calculation processing function and perform a specific operation. For example, the processor 230 may execute the program stored in the memory 220 and perform the encryption operation, the electronic signature operation, and/or the key distribution operation instructed by commands included in the program according to the execution.

For example, the processor 230 may be one of a central processing unit (CPU), a micro controller unit (MCU), a field programmable gate array (FPGA), an application specified integrated circuit (ASIC), and a graphical processing unit (GPU), but the embodiments of the present disclosure are not limited thereto.

The operation of the device 200 according to the embodiments of the present disclosure may be implemented in the form of a program stored in a computer-readable nonvolatile storage medium.

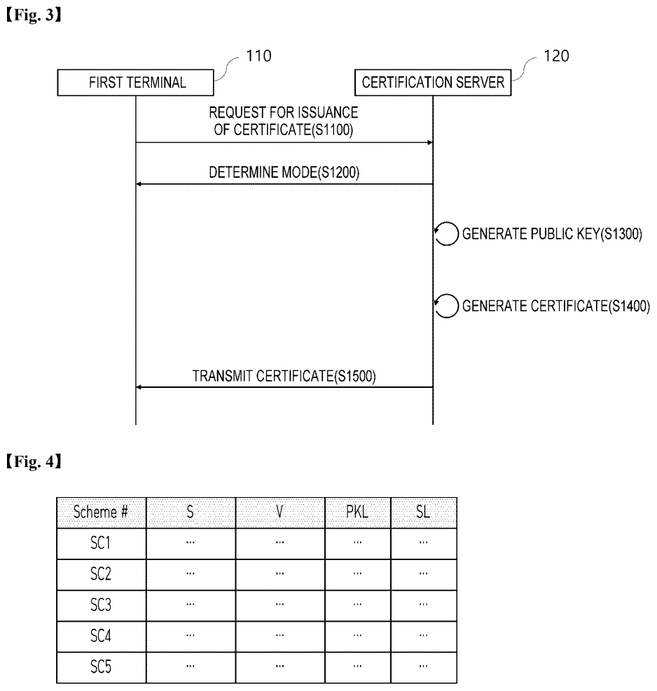

FIG. 3 is a view for describing operations of a first terminal and a certification server according to the embodiments of the present disclosure. In FIG. 3, the first terminal 110 and the certification server 120 are described exemplarily, but the embodiments of the present disclosure may be applied to any upper-level and lower-level entities.

According to the certification system according to the embodiments of the present disclosure, an encryption scheme used by each subject may be determined based on a usage environment of the certification system. According to embodiments, a mode corresponding to the usage environment of the certification system may be determined, and the encryption scheme related to each subject may be selected according to the determined mode.

In this case, the mode may be a mode in which at least one of a certificate size, a verification speed, a ciphertext generation speed, and a ciphertext length (or size) is prioritized. For example, the mode may include a mode in which the size of the certificate is minimized, a mode in which both the certificate size and the ciphertext length are minimized, a mode in which the ciphertext generation speed is prioritized, and a mode in which the verification speed is prioritized.

Here, the ciphertext is result data obtained by processing (or encrypting) data using a public key or a private key. For example, in the case of the electronic signature system, the ciphertext may be an electronic signature for a message. In addition, for example, in the case of the KEM method, the ciphertext may be the result of encrypting a private key.

The determination of the mode and the determination of the encryption scheme may be made by the certification server 120 or the first terminal 110.

For example, the certification server 120 may receive information about the mode corresponding to the usage environment and based on the mode, may determine a certification encryption scheme related to the certification server 120 and terminal encryption schemes related to the terminals 110 and 130 among the possible encryption schemes.

Here, the “possible encryption scheme” is an encryption scheme stored in the certification server 120 or accessible to the certification server 120 and is, for example, an encryption scheme that satisfies a predetermined condition (e.g., a security level) required by the certification system 10. That is, the possible encryption scheme in the certification system 10 may be, for example, an encryption scheme allowed by the certification system 10.

In this case, the certification encryption scheme is an encryption scheme used when the certification server 120 generates a public key certificate, that is, when the certification server 120 generates its public key. In addition, the terminal encryption scheme is an encryption scheme used when generating the public key of the terminal 110.

Alternatively, the certification server 120 may determine an encryption scheme related to each subject based on a security level required by each subject of the certification system 10.

Meanwhile, when the terminal encryption scheme to be used when generating the public key of the first terminal 110 is determined, it goes without saying that the second terminal 130 performing an encryption operation (e.g., electronic signature or verification) using the public key of the first terminal 110 also uses the determined terminal encryption scheme.

In this case, the certification server 120 may provide information about the terminal encryption scheme to be used by the first terminal 110 to the first terminal 110.

Meanwhile, for example, the first terminal 110 may provide a screen for selecting a mode to a user of the first terminal 110. At this time, the user may select a desired mode through the screen. That is, the first terminal 110 may receive an input for a mode from the user. Thereafter, the first terminal 110 receives the input for the mode and determines a terminal encryption scheme corresponding to the above input.

At this time, the first terminal 110 may provide information about the first terminal encryption scheme to be used by the first terminal 110 to the certification server 120.

According to embodiments, an encryption scheme related to a lower-level subject may be installed by being transmitted from an upper-level subject. For example, in the case of FIG. 1, the certification server 120 may transmit the information about the terminal encryption scheme to the first terminal 110.

Referring to FIG. 3, the first terminal 110 may transmit a request for instructing the issuance of a public key certificate for certificating the validation of the public key of the first terminal 110 to the certification server 120 (S1100). According to embodiments, the first terminal 110 may transmit the identification information of the first terminal 110 or the user of the first terminal 110 together.

The mode may be determined in consideration of the usage environment of the certification system 10 (S1200). According to embodiments, the mode may be determined by the first terminal 110 or the certification server 120.

According to embodiments, the certification server 120 may read setting information corresponding to the usage environment and determine a mode corresponding to the above setting information. Thereafter, the certification server 120 may determine an authentication encryption scheme and a terminal encryption scheme among possible encryption schemes to correspond to the determined mode.

According to embodiments, the certification server 120 may determine an encryption scheme related to each device based on the security level required from each device (the first terminal 110 or the certification server 120) of the certification system 10.

For example, the certification server 120 may read information on the security level required by the certification server 120 and determine an authentication encryption scheme among possible encryption schemes in consideration of the corresponding security level and the electronic signature mode.

For example, the certification server 120 may read information on the security level required by the first terminal 110 and determine a terminal encryption scheme among the possible encryption schemes in consideration of the corresponding security level and the electronic signature mode.

Meanwhile, the terminal encryption scheme may be determined by the first terminal 110 rather than the certification server 120. According to embodiments, the first terminal 110 may provide a screen for selecting a mode to the user of the first terminal 110. At this time, the user may select a desired mode through the screen. That is, the first terminal 110 may receive an input for a mode from the user. Thereafter, the first terminal 110 receives the input for the mode and determines a terminal encryption scheme corresponding to the above input.

The first terminal 110 may transmit information about the determined terminal encryption scheme to the certification server 120, and then the certification server 120 may generate the public key of the first terminal 110 according to the terminal encryption scheme.

Meanwhile, the information about the mode or possible encryption scheme may be provided in advance from the certification server 120, but is not limited thereto.

The certification server 120 generates the public key of the first terminal 110 (S1300). According to embodiments, the certification server 120 may generate the public key of the first terminal 110 based on the terminal encryption scheme.

The certification server 120 may generate a certificate for the public key based on the public key and/or the user identification information (S1400). According to embodiments, the certification server 120 may generate a certificate including the public key of the first terminal 110, the identification information of the first terminal 110, and the electronic signature of the certification server 120 for the public key and the identification information.

In this case, the certification server 120 may generate an electronic signature to be included in the certificate according to a certification encryption scheme corresponding to the determined mode.

According to embodiments, the certificate for the public key of the first terminal 110 may additionally include information about the terminal encryption scheme related to generating the public key and/or information about the certification encryption scheme related to generating the electronic signature of the certification server 120.

This may be used when the second terminal 130 uses the public key of the first terminal 110 or verifies the public key certificate. Therefore, the second terminal 130 can effectively identify the encryption scheme to be used in the process of using the public key or verifying the public key certificate.

The certification server 120 may transmit the generated public key certificate to the first terminal 110 (S1500). According to embodiments, the public key certificate may not be directly transmitted to the first terminal 110, but may be stored in a cloud environment to which the first terminal 110 may access.

Meanwhile, although FIG. 3 shows that the public key of the first terminal 110 is generated by the certification server 120, according to embodiments, the public key of the first terminal 110 may be directly generated by the first terminal 110.

For example, the first terminal 110 may receive the information about the terminal encryption scheme from the certification server 120 and generate the public key according to the corresponding terminal encryption scheme. The generated public key may be transmitted to the certification server 120 and used when the public key certificate is generated later.

Even in this case, it goes without saying that the terminal encryption scheme used to generate the public key of the first terminal 110 and the certification encryption scheme used when generating the certificate of the certification server 120 may be determined according to the mode. In this case, the certification server 120 may generate the public key of the first terminal 110 according to the terminal encryption scheme according to the determined mode and generate the public key certificate for the public key of the first terminal 110 according to the certification encryption scheme.

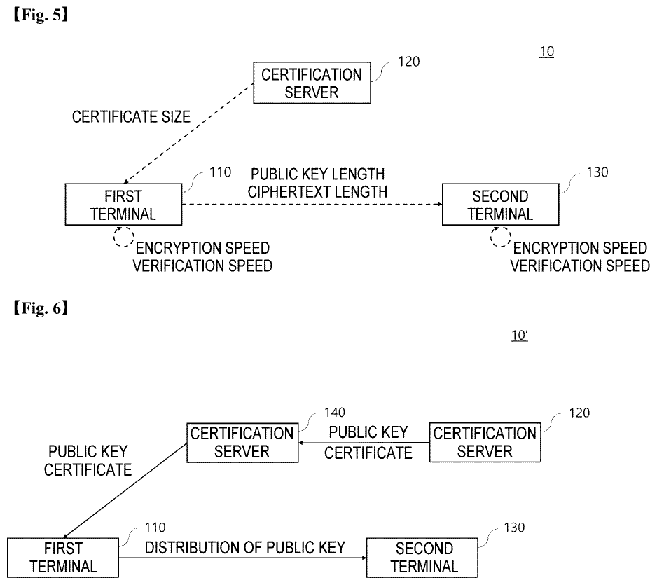

FIG. 4 is a view showing the performance of encryption schemes according to the embodiments of the present disclosure. Referring to FIG. 5, the performance of each of the encryption schemes SC1 to SC4 may be quantified by a ciphertext generation speed S, a verification speed V, a public key length PKL, and a ciphertext length SL.

The ciphertext generation speed is a speed at which each encryption scheme generates ciphertext (or encrypted data) according to a predetermined condition. The ciphertext generation speed may be inversely proportional to the time or cycle required to generate the corresponding ciphertext. For example, in the case of the electronic signature system, the ciphertext generation speed is an electronic signature generation speed, and in the case of the KEM method, the ciphertext generation speed is a ciphertext generation speed of a symmetric key (or symmetric key seed).

The verification speed is a speed of verifying (i.e., decrypting) the ciphertext generated according to each encryption scheme. The verification speed may be inversely proportional to the time or cycle required to verify the corresponding ciphertext. For example, the verification speed may be all of a verification speed of the electronic signature in the electronic signature system, the speed of decrypting the symmetric key ciphertext in the KEM method, or the speed of verifying the public key certificate.

The public key length is a length of the public key generated by the encryption scheme. That is, the public key length is a length of the public key of the first terminal 110 generated by the terminal encryption scheme.

The ciphertext length is a length of the ciphertext generated by the encryption scheme. For example, the ciphertext length may be a length of the electronic signature of the certification server 120 generated by the certification encryption scheme, or the length of the ciphertext (e.g., the private key ciphertext or the electronic signature of the terminal 110) generated by the terminal encryption scheme.

In the certification system according to the embodiments of the present disclosure, an encryption scheme to be used is selected in consideration of the usage environment of the certification system. Specifically, the selection of the encryption scheme may be made by selecting an electronic signature with excellent specific performance according to the usage environment.

In this case, performance comparison between the encryption schemes is assumed to be made under the same security or the same security strength. This is because objective comparison is possible only under the same security. In addition, the performance comparison is made assuming that external variables (e.g., a computational speed of a computer) other than the encryption scheme are also the same.

For example, when a first encryption scheme has a shorter public key length than a second encryption scheme, it means that, assuming that the same requirements (e.g., security) are satisfied, the minimum public key length required when using the first encryption scheme is shorter than the minimum public key length required when using the second encryption scheme. This is also applied to the comparison of the remaining performance.

FIG. 5 is a view for describing encryption scheme selection considering a usage environment according to the embodiments of the present disclosure. Referring to FIG. 5, the usage environment considered in the certification system 10 may be an environment related to the certificate size, the ciphertext generation speed, the ciphertext length (or size), and the verification speed.

According to the embodiments of the present disclosure, an encryption scheme to be used may be selected from possible encryption schemes (i.e., candidate encryption schemes) in consideration of the usage environment of the certification system 10. In this case, the “possible encryption schemes” to be selected are encryption schemes that are stored in the certification server 120 or accessible to the certification server 120 and may be selected in advance as encryption schemes that satisfy a predetermined criterion.

That is, depending on the usage environment, the terminal encryption scheme to be used in the first terminal 110 and the certification encryption scheme to be used in the certification server 120 may be determined.

For example, based on the security required by the certification system 10, an encryption scheme with the fastest ciphertext generation speed among the possible encryption schemes may be selected, or an encryption scheme with the shortest public key length may be selected, but the present disclosure is not limited thereto, and specific embodiments will be described below.

### From the Perspective of Minimizing Certificate Size

From the perspective of minimizing the public key certificate size generated by the certification server 120, the terminal encryption scheme may be selected. In this case, the shorter ciphertext length (i.e., electronic signature length) of the certification terminal encryption scheme and the shorter public key length of the terminal encryption scheme are preferable.

According to embodiments, based on the same plaintext, the ciphertext length according to the certification encryption scheme may be shorter than the ciphertext length according to the terminal encryption scheme.

In addition, according to embodiments, the public key length according to the terminal encryption scheme may be shorter than the public key length according to the certification encryption scheme.

For example, the certification encryption scheme may be an encryption scheme with the shortest electronic signature length among the possible encryption schemes, and the terminal encryption scheme may be an encryption scheme with the shortest public key length among the possible encryption schemes.

For example, the certification encryption scheme may be a multiplicative variable quadratic-based encryption scheme, and the terminal encryption scheme may be a lattice-based encryption scheme. More preferably, the certification encryption scheme may be the multiplicative variable quadratic-based encryption scheme, and the terminal encryption scheme may be an encryption scheme based on a number theory research unit (NTRU) lattice-based encryption algorithm.

### From the Perspective of Minimizing Certificate Size and Ciphertext Length

From the perspective of minimizing the ciphertext lengths of the terminals 110 and 130 together with the public key certificate size of the certification server 120, the encryption schemes may be selected. In this case, the shorter ciphertext length by the certification encryption scheme and the shorter (smaller) sum of the public key length and the ciphertext length by the terminal encryption scheme are preferable.

Here, the ciphertext length may be a length of the electronic signature, but is not limited thereto.

According to embodiments, the ciphertext length by the certification encryption scheme may be shorter than the ciphertext length by the terminal encryption scheme. In addition, the sum of the signature length and the public key length of the terminal encryption scheme may be less than the sum of the signature length and the public key length of the certification encryption scheme.

For example, the certification encryption scheme may be the encryption scheme with the shortest electronic signature length among the possible encryption schemes. In addition, the terminal encryption scheme may be an encryption scheme with the shortest sum of the public key length and the signature length among the possible encryption schemes.

For example, the certification encryption scheme may be a multiplicative variable quadratic-based encryption scheme, and the terminal encryption scheme may be a lattice-based encryption scheme. More preferably, the certification encryption scheme may be the multiplicative variable quadratic-based encryption scheme, and the terminal encryption scheme may be an encryption scheme based on an NTRU lattice-based encryption algorithm.

### From the Perspective of Giving Top Priority to Ciphertext Generation Performance

Encryption schemes may be selected from the perspective of giving top priority to the ciphertext generation of the terminals 110 and 130. For example, the encryption schemes may be selected from the perspective of giving top priority to the performance of electronic signature generation of the terminals 110 and 130 or the private key ciphertext generation of the terminals 110 and 130. In this case, the faster ciphertext generation speed of the terminal encryption scheme is preferable.

According to embodiments, the signature generation speed of the terminal encryption scheme may be higher than the signature generation speed of the certification encryption scheme. For example, the terminal encryption scheme may be the encryption scheme with the fastest signature generation speed among the possible encryption schemes.

For example, the terminal encryption scheme may be a lattice-based encryption scheme. More preferably, the terminal encryption scheme may be a lattice-based module or an encryption scheme based on the LWE problem on a ring domain.

### From the Perspective of Giving Top Priority to Verification Performance

The encryption schemes may be selected from the perspective of giving top priority to the verification of the public key certificate issued by the certification server 120 and/or the verification (or decryption) performance of the ciphertexts of the terminals 110 and 130. In this case, the faster verification speed of the certification encryption scheme and/or the faster verification speed of the terminal encryption scheme are preferable.

For example, when top priority is given to the verification performance of the public key certificate, the certification encryption scheme may be selected as a multiplicative variable quadratic-based or lattice-based encryption scheme.

For example, when top priority is given to the verification performance of the public key certificate and the verification (or decryption) performance of the ciphertext, both the certification encryption scheme and the terminal encryption scheme may be lattice-based encryption schemes, for example, encryption schemes based on the module LWE problem or the ring LWE problem.

FIG. 6 is a view for describing the encryption scheme selection considering the usage environment according to the embodiments of the present disclosure. Compared to FIGS. 1 and 5, a certification system 10′ of FIG. 6 is different in that it further includes an intermediate certification server 140.

The intermediate certification server 140 is a subject that plays a similar role to the certification server 120 and may issue a public key certificate for the public key of the first terminal 110. In this case, the public key certificate of the intermediate certification server 140 may include the electronic signature of the intermediate certification server 140.

In this case, the certification server 120 may issue a public key certificate for the public key of the intermediate certification server 140. As described above, the public key certificate by the intermediate certification server 140 includes the electronic signature of the intermediate certification server 140, but the validity of such an electronic signature is problematic. Therefore, since a trustworthy certification server 120 is present as an upper-level subject of the intermediate certification server 140, the certification server 120 may generate the public key certificate for the public key of the intermediate certification server 140.

As in FIG. 5, in the certification system 10′ of FIG. 6, encryption schemes may be selected in consideration of the usage environment including the certificate size, the signature generation speed, the electronic signature size, and the verification speed. Hereinafter, the description of the same part will be omitted, and the encryption scheme used in the certification server 120 is referred to as a first certification encryption scheme, and the second certification encryption scheme is referred to as the second certification encryption scheme.

### From the Perspective of Minimizing Certificate Size

Encryption schemes may be selected from the perspective of minimizing the certificate size of the certification servers 120 and 140. In this case, the shorter ciphertext length (i.e., the electronic signature length) by the first certification encryption scheme, the shorter (smaller) sum of the ciphertext length (i.e., the electronic signature length) by the second certification encryption scheme and the public key length, and the shorter public key length of the terminal encryption scheme are preferable.

According to embodiments, the signature length of the first certification encryption scheme may be shorter than the signature lengths of the encryption schemes used in other devices 110 and 130, and the sum of the signature length and the public key length of the second certification encryption scheme may be smaller than the sum of the signature lengths and the public key lengths of the encryption schemes used in other devices 110 and 120, and the public key length of the terminal encryption scheme may be shorter than the public key lengths of the encryption schemes used in other devices 120 and 140.

For example, the first certification encryption scheme may be an encryption scheme with the shortest signature length among the possible encryption schemes, the second certification encryption scheme may be an encryption scheme with the shortest signature length and public key length among the possible encryption schemes, and the terminal encryption scheme may be an encryption scheme with the shortest public key length among the possible encryption schemes.

For example, the first certification encryption scheme may be a multiplicative variable quadratic-based encryption scheme, and the encryption schemes used in the devices 110 and 140 may be a lattice-based encryption scheme. More preferably, the first certification encryption scheme may be a multiplicative variable quadratic-based encryption scheme, and the encryption schemes used in the devices 110 and 140 may be an encryption scheme based on an NTRU lattice-based encryption algorithm.

### From the Perspective of Minimizing Certificate and Ciphertext Sizes

Encryption schemes may be selected from the perspective of minimizing the ciphertext lengths (or sizes) of the terminals 110 and 130 together with the certificate size. In this case, the shorter signature length of the certification encryption scheme, and the shorter sum of the public key lengths and the signature lengths of the encryption schemes used in the devices 110 and 140 are preferable.

According to embodiments, the signature length of the first certification encryption scheme may be shorter than the signature lengths of the encryption schemes used in other devices 110 and 140, and the sum of the signature length and the public key length of the encryption scheme used in each of the devices 110 and 140 may be less than the sum of the signature length and the public key length of the certification encryption scheme.

For example, the first certification encryption scheme may be an encryption scheme with the shortest signature length among the possible encryption schemes, and the second certification encryption scheme and the terminal encryption scheme may be encryption schemes with the shortest sum of the signature length and the public key length among the possible encryption schemes.

For example, the first certification encryption scheme may be a multiplicative variable quadratic-based encryption scheme, and the encryption schemes used in the devices 110 and 140 may be a lattice-based encryption scheme. More preferably, the first certification encryption scheme may be a multiplicative variable quadratic-based encryption scheme, and the encryption schemes used in the devices 110 and 140 may be an encryption scheme based on an NTRU lattice-based encryption algorithm.

### From the Perspective of Giving Top Priority to Ciphertext Generation Performance

Encryption schemes may be selected from the perspective of giving top priority to the performance of generating ciphertexts (e.g., an electronic signature or private key ciphertext) of the terminals 110 and 130. In this case, the faster ciphertext generation speed of the terminal encryption scheme is preferable.

According to embodiments, the signature generation speed of the terminal encryption scheme may be faster than the signature generation speeds of the encryption schemes used in other devices 120 and 140. For example, the terminal encryption scheme may be an encryption scheme with the fastest signature generation speed among the possible encryption schemes.

For example, the terminal encryption scheme may be a lattice-based encryption scheme. More preferably, the terminal encryption scheme may be an encryption scheme based on the LWE problem on a lattice-based module domain.

### From the Perspective of Giving Top Priority to Certificate Verification Performance

Encryption schemes may be selected from the perspective of giving top priority to the verification performance for public key certificates of the certification servers 120 and 140. In this case, the faster verification speeds of the certification encryption schemes used in the certification servers 120 and 140 are preferable.

According to embodiments, the verification speed of the certification encryption schemes used in the certification servers 120 and 140 may be faster than the verification speed of the terminal encryption scheme. For example, the certification encryption schemes used in the certification servers 120 and 140 may be encryption schemes with the fastest verification speed among the possible encryption schemes.

For example, the certification encryption schemes used in the certification servers 120 and 140 may be a lattice-based encryption scheme. More preferably, the certification encryption schemes used in the certification servers 120 and 140 may be encryption schemes based on the module LWE problem or the ring LWE problem.

### From the Perspective of Giving Top Priority to Overall Verification Performance

Encryption schemes may be selected from the perspective of giving top priority to the verification performance of the public key certificates of the certification servers 120 and 140 and the ciphertexts of the terminals 110 and 130. In this case, the shorter signature lengths of the encryption schemes used in all devices 110, 120, and 140 are preferable.

For example, the encryption schemes used in the devices 110, 120, and 140 may be encryption schemes with the fastest signature verification speed among the possible encryption schemes.

For example, the encryption schemes used in the devices 110, 120, and 140 may be lattice-based encryption schemes. More preferably, the encryption schemes used in the devices 110, 120, and 140 may be encryption schemes based on the module LWE problem or the ring LWE problem.

Referring to FIGS. 5 and 6, the multiplicative variable quadratic-based encryption scheme may be selected as a certification encryption scheme from the perspective of minimizing the size of the certificate.

According to the embodiments of the present disclosure, since the encryption scheme used by each subject is selected in consideration of the usage environment of the certification system, it is possible to increase the user's signature generation speed, the verifier's verification speed, the transmission amount, and the like compared to the system that uses the same encryption scheme.

Meanwhile, although the present specification has described the certification system as an example, the embodiments of the present disclosure be applied to all encryption systems that use substantially the same structure as an electronic signature in addition to a certification system in the general sense.

In the certification system, a sender encrypts a message using his or her own private key and generates the encrypted message, and a verifier verifies the corresponding electronic signature with the sender's public key. Therefore, the embodiments of the present disclosure are also applied to an encryption system in which any plaintext is encrypted using a public key (or a private key) and the encrypted plaintext is verified using a private key (or a public key).

For example, in the KEM, a message or a symmetric key is encrypted using the sender's private key and transmitted, and the receiver decrypts and verifies the corresponding ciphertext using the sender's public key. In addition, a certification subject is present for proof of the identity of the sender's subject. Therefore, it should be understood that due to such similarity, the embodiments of the present disclosure are applied to the KEM in the same manner.

The above description is merely the exemplary description of the technical spirit of the present disclosure, and those skilled in the art to which the present disclosure pertains will be able to variously modify and change the present disclosure without departing from the essential characteristics of the present disclosure. Therefore, the embodiments disclosed in the present invention are not intended to limit the technical spirit of the present invention, but intended to describe the same, and the scope of the technical spirit of the present invention is not limited by these embodiments. The scope of the present disclosure should be construed by the appended claims, and all technical ideas within the equivalent scope should be construed as being included in the scope of the present disclosure.

The above-described device (unit) may be implemented as a hardware element and/or a software element. For example, the hardware element may include a microphone, an amplifier, a bandpass filter, an A/D converter, and a processing device. The processing device may be implemented by using one or more general-purpose or special-purpose computers such as include, for example, a processor, a controller, an arithmetic logic unit (ALU), a digital signal processor, a microcomputer, a FPGA, a programmable logic unit (PLU), a microprocessor, or other devices capable of responding to and executing instructions in a defined manner. The processing device may run an operating system (OS) and one or more software applications running on the operating system. In addition, the processing device may access, store, manipulate, process, and generate data in response to the execution of software. For simple description, the processing device may be described as one, but those skilled in the art can know that the processing device may include multiple processing elements and/or multiple types of processing elements. For example, the processing device may include a plurality of processors or a processor and a controller. In addition, other processing configurations, such as parallel processors, are possible.

Software may include computer programs, code, instructions, or combinations thereof, which may independently or collectively configure or instruct the processing device to operate as desired. The software and data may be expressed as propagated signal waves that may be interpreted by and may provide instructions or data to a processing device, or may be embodied permanently or temporarily in various types of machines, components, physical devices, virtual devices, computer storage media or devices, etc. The software may be distributed over networked computer systems and thus stored and executed in a distributed manner. The software and data may be stored in one or more computer-readable recording media, which includes a data storage device for storing data and then readable by the computer system or the processing device. A method according to the embodiment may be implemented in a form of program instructions that may be performed through various computer devices and recorded on a computer-readable medium. Examples of computer-readable recording media include a ROM, a RAM, a CD-ROM, a magnetic tape, a floppy disk, and an optical data storage device. Examples of the computer-readable recording medium include magnetic media such as a hard disk, a floppy disk, and a magnetic tape, optical media such as a CD-ROM and a DVD, and magneto-optical media such as a floptical disk, and hardware devices specifically configured to store and execute program instructions, such as a ROM, a RAM, and a flash memory. In addition, the functional programs, code, and code segments that complete the examples disclosed herein can be easily understood and implemented by a programmer having ordinary skill in the art related to these examples based on or using the flowchart and block diagrams of the drawings and the related descriptions provided herein.

Although not universal, the terminals or devices described herein may be applied to mobile devices such as a cellular phone, a PDA, a digital camera, a portable game console, an MP3 player, a portable/personal multimedia player (PMP), a portable e-book, a portable laptop PC, a GPS navigation system, a tablet PC, and a sensor, a desktop PC, a HDTV, an optical disc player, a set-top box, home appliance, and devices capable of wireless or network communication.

In addition, the computer-readable medium may include program instructions, data files, data structures, etc. alone or in combination. The program instructions recorded on the medium may be specially designed and constructed for the embodiments or may be known and available to those skilled in the art of computer software. Examples of the program instructions include not only machine language code such as that produced by a compiler but also high-level language code that may be executed by a computer using an interpreter, etc. The hardware device may be configured to operate as one or more software modules to perform the operation of the embodiments, and vice versa.

Although several embodiments have been described above, it should be understood that various modifications can be made. For example, appropriate results can be achieved even when the techniques described are performed in a different order and/or elements of the stated system, structure, device, circuit, etc. are coupled in a different way or replaced with or supplemented by other elements or equivalents. Therefore, other implementations also fall within the scope of the appended claims.

1. A method of operating a certification server of a public key certificate system, the method comprising:
receiving a request for issuance of a public key certificate from a terminal;
determining a terminal encryption scheme and a certification encryption scheme among encryption schemes allowed in the public key certificate system;
generating a public key of the terminal according to the terminal encryption scheme;
generating a public key certificate for verifying the validity of the public key of the terminal according to the certification encryption scheme; and
transmitting the public key certificate to the terminal.

2. The method of claim 1, wherein the generating of the public key certificate includes:
generating an electronic signature for the public key of the terminal and identification information of the terminal, according to the certification encryption scheme; and
generating the public key certificate including the public key, the identification information, and the electronic signature.

3. The method of claim 2, wherein the public key certificate further includes information about the terminal encryption scheme and the certification encryption scheme.

4. The method of claim 1, wherein the determining of the terminal encryption scheme and the certification encryption scheme further includes receiving an input effective in determining the terminal encryption scheme from the terminal and determining the terminal encryption scheme based on the received input.

5. The method of claim 1, wherein the determining of the terminal encryption scheme and the certification encryption scheme further includes:
reading setting information about a usage environment of the public key certificate system; and
determining the terminal certification scheme and the certification encryption scheme based on the setting information.

6. The method of claim 1, wherein the certification encryption scheme is an encryption scheme with the shortest ciphertext length among the allowed encryption schemes.

7. The method of claim 6, wherein the terminal encryption scheme is an encryption scheme with the shortest public key length among the allowed encryption schemes.

8. The method of claim 6, wherein the terminal encryption scheme is an encryption scheme with the shortest sum of the public key length and the ciphertext length.

9. The method of claim 6, wherein the certification encryption scheme is a multiplicative variable quadratic-based encryption scheme.

10. The method of claim 7, wherein the terminal encryption scheme is an encryption scheme based on a number theory research unit (NTRU) lattice-based encryption algorithm.

11. A certificating method of a public key certificate system including a first terminal and a certification server, the method comprising:
receiving, by the certification server, a request for issuance of a public key certificate from the first terminal;
determining, by the certification system or the first terminal, a terminal encryption scheme and a certification encryption scheme among encryption schemes allowed in the public key certificate system;
generating, by the certification server, a public key of the first terminal according to the terminal encryption scheme;
generating, by the certification server, a public key certificate for verifying the validity of the public key of the first terminal according to the certification encryption scheme; and
transmitting, by the certification server, the public key certificate to the first terminal.

12. The method of claim 11, further comprising:
generating, by the first terminal, an electronic signature for a message using a private key corresponding to the public key;
transmitting, by the first terminal, the electronic signature and the public key certificate to a second terminal;
verifying, by the second terminal, the public key certificate according to the certification encryption scheme; and
verifying, by the second terminal, the electronic signature using the public key of the first terminal according to the terminal encryption scheme when the public key certificate is valid,
wherein the public key certificate system further includes the second terminal.

13. The method of claim 11, further comprising:
acquiring, by a second terminal, the public key certificate;
verifying, by the second terminal, the public key certificate according to the certification encryption scheme;
encrypting, by the second terminal, a message using the public key of the first terminal according to the terminal encryption scheme when the public key certificate is valid and transmitting the encrypted message to the first terminal; and
decrypting, by the first terminal the encrypted message using a private key of the first terminal,
wherein the public key certificate system further includes the second terminal.

14. The method of claim 11, wherein the determining of the terminal encryption scheme and the certification encryption scheme that are suitable for the public key certificate system further includes:
transmitting, by the first terminal, an input effective for determining the terminal encryption scheme to the certification server; and
determining, by the certification server, the terminal encryption scheme based on the received input.

15. The method of claim 11, wherein the determining of the terminal encryption scheme and the certification encryption scheme that are suitable for the public key certificate system further includes:
reading, by the certification server, setting information about a usage environment of the public key certificate system; and
determining, by the certification server, the terminal certification scheme and the certification encryption scheme based on the setting information.

16. The method of claim 11, wherein the certification encryption scheme is an encryption scheme with the shortest ciphertext length among the allowed encryption schemes.

17. The method of claim 16, wherein the terminal encryption scheme is an encryption scheme with the shortest public key length among the allowed encryption schemes.

18. The method of claim 16, wherein the terminal encryption scheme is an encryption scheme with the shortest sum of the public key length and the ciphertext length.

19. The method of claim 16, wherein the certification encryption scheme is a multiplicative variable quadratic-based encryption scheme.

20. The method of claim 17, wherein the terminal encryption scheme is an encryption scheme based on a number theory research unit (NTRU) lattice-based encryption algorithm.
